(19) United States
(12) Patent Application Publication
(10) Pub. No.: US 2010/0242515 A1
(43) Pub. Date: Sep. 30, 2010

(54) EXTERNAL DECORATIVE MEMBER FOR REFRIGERATOR AND MANUFACTURING METHOD THEREOF

(75) Inventor: Jung Hun Kim, Changwon-shi (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/445,195

(22) PCT Filed: Oct. 1, 2007
(86) PCT No.: PCT/KR2007/004780

§ 371 Date: May 17, 2010

(30) Foreign Application Priority Data
Oct. 13, 2006 (KR) 10-2006-0099743

(51) Int. Cl. F25D 23/02; B44C 1/22

(52) U.S. Cl. 62/259.1; 216/31

(57) ABSTRACT

The present invention relates to an external decorative member that can defines an exterior appearance of a refrigerator, considering various kinds of patterns and consumers demands for independent exterior beauty. An external decorative member for a refrigerator, which is attached to a front surface of an outer case defining an exterior of the refrigerator, having a glass member (200) formed in a size corresponding to the outer case, the external decorative member, wherein an image (220) is formed on the glass member by an etching process. A manufacturing method of an external decorative member for a refrigerator includes a sketch step (S100) in which a wished image (220) is printed on a front surface of a glass member (200) for defining an exterior of the refrigerator, and an etching step (S200) in which a pattern of the image printed in the sketch step (S100) is formed by an etching process.

### TECHNICAL FIELD

The present invention relates to a refrigerator. More particularly, the present invention relates to an external decorative member that can define an exterior appearance of a refrigerator, considering various kinds of patterns and consumers's demands for independent exterior beauty.

### BACKGROUND ART

Refrigerators are home appliances in which cold air is produced by an operation of a freezing cycle and the cold air is supplied to a refrigerator compartment and a freezer compartment to preserve food items at a relatively low temperatures for a long time.

The freezing cycle is configured of a compressor, a condenser, a capillary tube and an evaporator. A refrigerant path is formed in the evaporator. Low temperature and low pressure liquid refrigerant is flowing along the refrigerant path and the liquid refrigerant absorbs heat of air near the evaporator to change the heat into cold air.

Doors are coupled to fronts of the refrigerator and freezer compartments, respectively. The doors open and close the refrigerator and freezer compartments, respectively, so that food items may be put in or taken out from the refrigerator and freezer compartments.

In addition, various kinds of external decorative members are applicable to a refrigerator to enhance an overall exterior beauty of a refrigerator. FIG. 4 is a perspective view illustrating a refrigerator adapting a conventional external decorative member and FIG. 5 is a partially perspective view illustrating key parts of the conventional external decorative member.

As shown in FIGS. 4 and 5, doors 15 and 15 are coupled to a refrigerator compartment 12 and a freezer compartment provided in a refrigerator body 10, respectively. An external decorative member 20 is provided on an outer case (not shown), which appears front, in other words, outer surfaces of the doors 15 and 15′

The external decorative member 20 is configured of a glass member 22, a reflection material containing coat layer 24, a water-transfer-print layer 25 and a color coat layer 26. The glass member 22 is hardened by heat to have relatively high strength and it is provided on a front surface of a refrigerator door. The reflection material containing coat layer 24 is painted on a surface of the glass member 22 to be exposed outside the glass member 22. The water-transfer-print layer 25 uses a film water-transfer-printed on the reflection material containing coat layer 24. The color coat layer 26 is painted on an upper surface of the water-transfer-print layer 25.

The reflection material containing coat layer 24 is primarily painted on the glass member 22 and the water-transfer-printed film is water-transfer printed on the primarily coated reflection material containing coat layer 24. That is, glass having the reflection material containing coating material sprayed thereon is attached to a jig that can be printed and the jig is water-transfer printed to form the water-transfer print layer 25.

Hence, once the water-transfer print is complete, various kinds of color ceramic coating materials including white, black, blue and the like are sprayed uniformly by an automatic spray gun. The water-transfer-print layer 25 is secondarily painted and the color coat layer 26 is formed. Here, a heat drying process is performed between the processes for forming each layer.

The above external decorative member enables an exterior of the refrigerator not to be a simple single colored exterior but to be a more luxurious exterior by forming the reflection material containing coat layer 24 with various colors and patterns reflective on lights.

### DISCLOSURE OF INVENTION

### Technical Problem

However, the conventional external decorative member may have problems.

The conventional external decorative member results in increased printing degrees to present a luxurious pattern.

Because of the increased printing degree, there might be a problem of high production cost.

Furthermore, such conventional external decorative member fails to satisfy modern customers who demands luxurious designs.

### Technical Solution

Accordingly, the present invention is directed to an external decorative member for a refrigerator.

An object of the present invention is to provide an external decorative member for a refrigerator that can present more dimensional exterior of a refrigerator by using a glass member processed by an etching process.

Another object of the present invention is to provide an external decorative member for a refrigerator that can apply a wished pattern according to customers' taste to a front surface of a refrigerator.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an external decorative member for a refrigerator, which is attached to a front surface of an outer case defining an exterior of the refrigerator, having a glass member formed in a size corresponding to the outer case, the external decorative member, wherein an image is formed on the glass member by an etching process.

Here, in the etching process, sands may be injected in a high pressure along a pattern of an image printed on a front surface of the glass member to process the image dimensionally.

In the etching process, a predetermined chemical may be processed on the glass member and glass may be oxidized along the pattern of the image printed on the front surface of the glass member to process the image dimensionally.

In another aspect of the present invention, an external decorative member for a refrigerator includes an outer case that defines an exterior of the refrigerator; and a glass member attached to a front surface of the outer case, in a size corresponding to the outer case, wherein an image is formed on the glass member by an etching process.

In further aspect of the present invention, a manufacturing method of an external decorative member for a refrigerator includes a sketch step in which a wished image is printed on a front surface of a glass member for defining an exterior of the refrigerator; and an etching step in which a pattern of the image printed in the sketch step is formed by an etching process.

In the etching step, sands may be injected in a high pressure along the pattern of the printed image to process the image dimensionally.

It is preferable that the thickness of the glass member is 5-10 mm.

In the etching step, a predetermined chemical may be processed on the glass member and glass may be oxidized along the pattern of the image printed on the front surface of the glass member to process the image dimensionally.

It is preferable that the chemical is configured of hydrogen fluoride.

The manufacturing method may further includes a pattern forming step in which a design a consumer wishes is selected, prior to the sketch step.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a perspective view illustrating a refrigerator having an external decorative member according to the present invention;

FIG. 2 is a partially perspective view illustrating the external decorative member;

FIG. 3 is a flow chart illustrating a manufacturing method of the external decorative member according to the present invention;

FIG. 4 is a perspective view illustrating a refrigerator having a conventional external decorative member;

FIG. 5 is a partial perspective view illustrating key parts of the conventional external decorative member.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

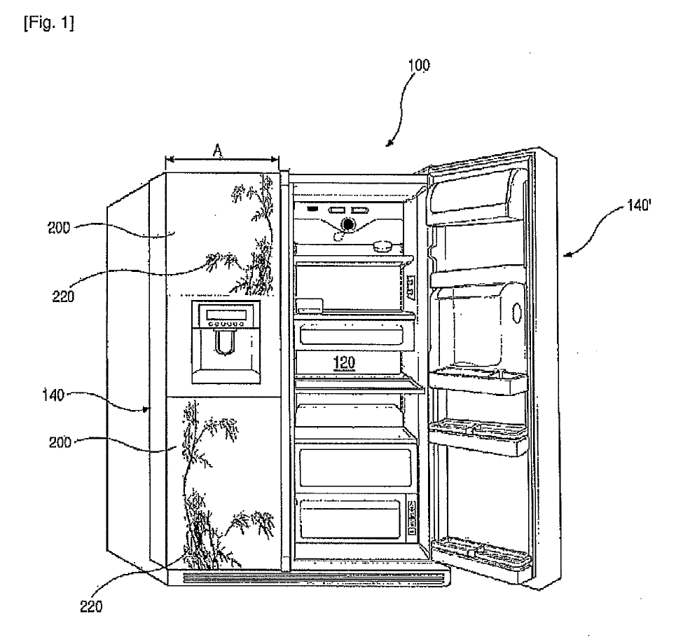

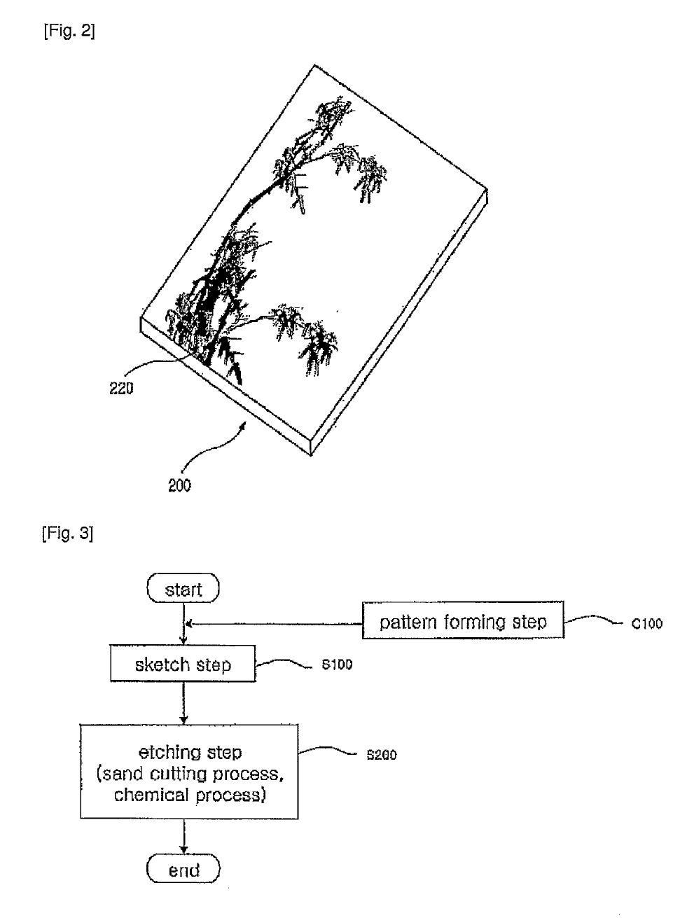

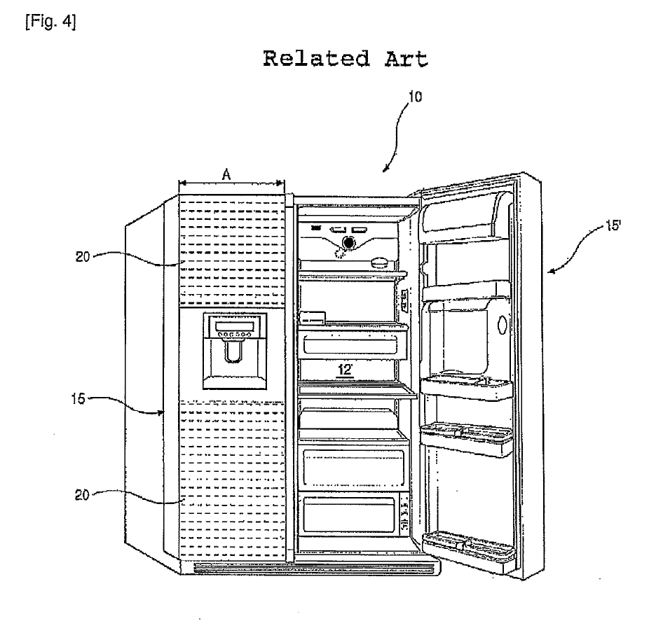

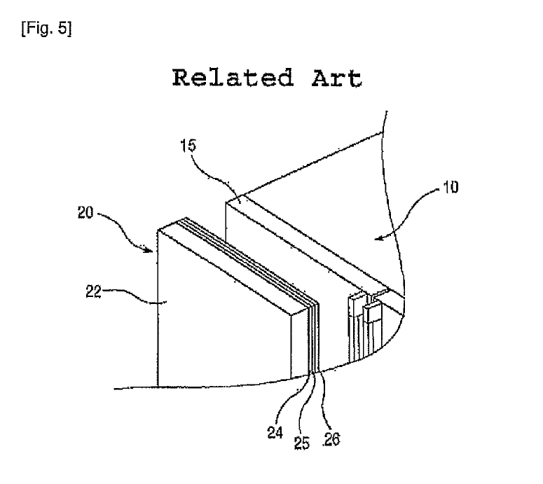

FIG. 1 is a perspective view illustrating a refrigerator having an external decorative member according to the present invention. FIG. 2 is a partial perspective view illustrating the external decorative member.

As shown in FIGS. 1 and 2, a refrigerator body 100 is approximately rectangular-shaped and an exterior of a front of the refrigerator is defined by doors 140 and 140′. The doors 140 and 140′ are rotatable with respect to a predetermined side of the refrigerator body 100, to open and close a refrigerator compartment 120 and a freezer compartment formed in the refrigerator body 100. Here, an external decorative member is provided on an outer case (not shown) forwardly exposed, which means an outer surface of the refrigerator.

The external decorative member is hardened by heat to have relatively high strength and it includes a glass member 200 provided on a front surface of the outer case (not shown). An image 220 is etching-processed and formed on the glass member 200.

More specifically, the glass member 200 is formed in a size corresponding to each surface of the outer case that defines the refrigerator body 100, and the glass member 200 is attached to the outer case.

It is preferable that the thickness of the glass member 200 is 5-10 mm, so that the glass member 200 may have a predetermined strength without high production cost.

The image 220 may be formed on the front surface of the glass member 200 in various appearances by an etching process. Once a wished appearance is drawn on the front surface of the glass member 200, two methods may be selectively useable. One of the methods is that the glass member 200 is cut along the drawn appearance by using sands and the other is that the glass member 200 is oxidized along the drawn appearance by using chemicals.

Next, a method of forming the image 220 on the external decorative member will be explained.

FIG. 3 is a flow chart illustrating a manufacturing method of the external decorative member according to the present invention.

As shown in FIG. 3, a manufacturing method of the external decorative member includes a sketch step S 100 and an etching step S200. In the sketch step S 100, a wished image 200 is drawn on the front surface of the glass member 200. In the etching step S200, a pattern of the image designed in the sketched step S100 is etching-processed.

In addition, in the sketch step S 100, a printing method of the design pattern may be varied based on etching-processing methods of the etching step S200, which will be explained in detail.

When performing the etching step S200 by using etching reagent, a protection film is formed on a predetermined portion of the front surface of the glass member 200 that is not wished to be etched. As a result, the portion is not oxidized because of the protection film and the design pattern is printed.

According to another embodiment, when performing the etching step S200 by using sands, a design pattern is printed on the front surface of the glass member 200 to draw a predetermined portion that will be cut by sands.

On the other hand, a pattern forming step C100 may be performed, prior to the sketch step S100. In the pattern forming step C100, a design pattern may be selected and a design a consumer wishes is selected and the design may be applied to the external decorative member.

Once the sketch step S100 is complete after the pattern forming step C100, the etching step S 100 starts.

In the etching step S200, a process corresponding to the printing method on the front surface of the glass member 20 is performed. First, a process using sands (hereinafter, “sand cutting process”) will be described.

To perform the etching step S200 by using the sand cutting process, a cutting portion is drawn on the front surface of the glass member 200 in the sketch step S100.

Hence, high pressure minute sands may be processed along a line of the drawn pattern by an injection device. At this time, the thickness of cutting may be variable based on the thickness of the glass member 200. It is preferable that the cutting is not thicker than a half of the thickness of the glass member 200, considering the strength of the finished glass member 200.

In addition, the portion having the cutting process performed thereon may be semi-transparent.

In the meantime, to present a more complex design than the design performed in the sand cutting process, another process using chemicals (hereinafter, “chemical process”) is performed.

To perform the etching step S200 using the chemical process, a protection coating film is printed on a predetermined portion of the front surface of the glass member 200, except a portion that will be etched. Here, it is preferable that the coating film is formed of material not oxidized by hydrogen fluoride.

In a state of the coating film being printed, the chemical, that is, hydrogen fluoride is processed on the front surface of the glass member 200. As a result, the portion of the glass member 200 where the coating film is not printed is oxidized by the hydrogen fluoride and the design pattern drawn in the sketch step S 100 is formed.

Here, the design pattern is formed semitransparent, which is identical to the design pattern formed in the sand cutting process.

Next, an operation of the external decorative member for the refrigerator will be explained.

The image 220 is formed on the external decorative member for the refrigerator according to the present invention by the etching process.

The image 220 is cut or oxidized by the chemical and a processed surface of the image is semitransparent. As a result, the design pattern formed on the glass member 200 may disperse lights and the semitransparent lighting effects allows subdued mood.

In addition, various design patterns are applied according to consumers taste before processing. As a result, a value of a refrigerator is enhanced from a general electric appliance to a piece of art that presents beauty, which allows the refrigerator to be an interior decoration.

### INDUSTRIAL APPLICABILITY

Therefore, the external decorative member for the refrigerator with above configuration and the manufacturing method thereof may have following industrial applicability.

First, the etching processed image is formed on the glass member that defines an exterior of the refrigerator. As a result, exterior beauty of the refrigerator is enhanced and a value of the refrigerator can be relatively high.

Furthermore, such image could be formed variously according to customers taste, which may satisfy customers inclined to unique and luxurious designs. As a result, product reliability and brand recognition may be improved.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An external decorative member for a refrigerator, which is attached to a front surface of an outer case defining an exterior of the refrigerator, having a glass member formed in a size corresponding to the outer case, the external decorative member, wherein an image is formed on the glass member by an etching process.

2. The external decorative member of claim 1, wherein, in the etching process, sands is injected in a high pressure along a pattern of an image printed on a front surface of the glass member to process the image dimensionally.

3. The external decorative member of claim 2, wherein, in the etching process, a predetermined chemical is processed on the glass member and glass is oxidized along the pattern of the image printed on the front surface of the glass member to process the image dimensionally.

4. An external decorative member for a refrigerator comprising:
an outer case that defines an exterior of the refrigerator; and
a glass member attached to a front surface of the outer case, in a size corresponding to the outer case, wherein an image is formed on the glass member by an etching process.

5. A manufacturing method of an external decorative member for a refrigerator comprising:
a sketch step in which a wished image is printed on a front surface of a glass member for defining an exterior of the refrigerator; and
an etching step in which a pattern of the image printed in the sketch step is formed by an etching process.

6. The manufacturing method of claim 5, wherein, in the etching step, sands is injected in a high pressure along the pattern of the printed image to process the image dimensionally.

7. The manufacturing method of claim 6, wherein the thickness of the glass member is 5-10 mm.

8. The manufacturing method of claim 5, wherein, in the etching step, a pre-determined chemical is processed on the glass member and glass is oxidized along the pattern of the image printed on the front surface of the glass member to process the image dimensionally.

9. The manufacturing method of claim 8, wherein the chemical is configured of hydrogen fluoride.

10. The manufacturing method of claim 5, further comprising:
a pattern forming step in which a design a consumer wishes is selected, prior to the sketch step.
